(19) United States
(12) Patent Application Publication
(10) Pub. No.: US 2022/0027811 A1
(43) Pub. Date: Jan. 27, 2022

(54) Systems and Methods for Performing Predictive Risk Sparing

(71) Applicant: The United States of America, as represented by the Secretary of the Navy, Crane, IN (US)

(72) Inventors: Anand Agrawal, Irvine, CA (US); Benny Cheng, Chino Hills, CA (US); James Dai, Crane, IN (US); Nicholas Hymer, Upland, CA (US); Raymond Ward, Cypress, CA (US)

(73) Assignee: The United States of America, as represented by the Secretary of the Navy, Arlington, VA (US)

(21) Appl. No.: 17/385,190

(22) Filed: Jul. 26, 2021

Related U.S. Application Data
(60) Provisional application No. 63/056,916, filed on Jul. 27, 2020.

(51) Int. Cl. G06Q 10/06; G06N 20/00; G06N 7/00; G06Q 10/00; G06Q 50/30

(52) U.S. Cl. CPC G06Q 10/0635; G06N 20/00; G06Q 50/30; G06Q 10/06313; G06Q 10/20; G06N 7/005

(57) ABSTRACT

Systems and methods for part prioritization in accordance with embodiments of the invention are illustrated. One embodiment includes a method for determining part priorities. The method includes steps for receiving part data for a set of one or more parts, the part data includes part failure data and part repair data, computing predicted lifecycle data based on the received part data, determining failure impact data based on the received part data, and generating an output based on the predicted lifecycle data and the failure impact data.

### CROSS-REFERENCE TO RELATED APPLICATIONS

The present application claims priority to U.S. Provisional Patent Application Ser. No. 63/056,916, filed Jul. 27, 2020, entitled “SYSTEMS AND METHODS FOR PERFORMING PREDICTIVE RISK SPARING,” the disclosure of which is expressly incorporated by reference herein.

### STATEMENT REGARDING FEDERALLY SPONSORED RESEARCH OR DEVELOPMENT

The invention described herein was made in the performance of official duties by employees of the Department of the Navy and may be manufactured, used and licensed by or for the United States Government for any governmental purpose without payment of any royalties thereon. This invention (Navy Case 200,530US02) is assigned to the United States Government and is available for licensing for commercial purposes. Licensing and technical inquiries may be directed to the Technology Transfer Office, Naval Surface Warfare Center Corona Division, email: CRNA_CTO@navy.mil.

### FIELD OF THE INVENTION

The present invention generally relates to prioritizing system parts and, more specifically, predictive methods for prioritizing system parts.

### BACKGROUND

Managing the availability of parts in complex systems can be difficult, where the failure of a critical part can have wide ranging consequences. For example, critical part failures on the U.S. Navy's forward deployed ships can significantly affect deployed operational availability and material readiness. Mission requirements of forward deployed vessels can often limit support access. Particularly in constrained environments, having the correct parts available at the correct times can be difficult and/or expensive to achieve. Determining when, where, and what to spare can be crucial to keeping critical systems operational in such environments.

### SUMMARY OF THE INVENTION

Systems and methods for part prioritization in accordance with embodiments of the invention are illustrated. One embodiment includes a method for determining part priorities. The method includes steps for receiving part data for a set of one or more parts, the part data includes part failure data and part repair data, computing predicted lifecycle data based on the received part data, determining failure impact data based on the received part data, and generating an output based on the predicted lifecycle data and the failure impact data.

In a further embodiment, the part failure data includes at least one of the time since the last failure, a failure rate, a mean time to failure, and how much time it has been used over its lifetime.

In still another embodiment, the part repair data includes at least one of a date of last repair, a repair rate, a level of effort to repair, a part availability, an estimated time to repair, and an estimated requisition time.

In a still further embodiment, the predicted lifecycle data includes a predicted number of failures for the set of parts over a period of time.

In yet another embodiment, computing the predicted lifecycle data is performed using a machine learning model.

In a yet further embodiment, computing the predicted lifecycle data includes modeling a timeline of the part as a continuous Markov process.

In another additional embodiment, determining the failure impact data comprises building a set of reliability block diagrams using a hierarchical structure, where determining failure impact data comprises analyzing relationships between parents and children along the hierarchical structure.

In a further additional embodiment, determining the failure impact data is performed using a machine learning model.

In another embodiment again, generating an output includes generating a risk matrix, wherein the risk matrix has a first axis indicating a likelihood of failure based on the predicted lifecycle data and a second axis indicating impact of a failure based on the determined failure impact data.

In a further embodiment again, generating an output includes generating a sparing budget to allocate available parts for storage on a vessel.

One embodiment includes a system comprising a non-transitory machine readable medium containing processor instructions for determining part priorities, where execution of the instructions by a processor causes the processor to perform a process that comprises receiving part data for a set of one or more parts, the part data includes part failure data and part repair data, computing predicted lifecycle data based on the received part data, determining failure impact data based on the received part data, and generating an output based on the predicted lifecycle data and the failure impact data.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 conceptually illustrates a process for determining part priorities in accordance with an embodiment of the invention.

FIG. 2 illustrates an example of a reliability block diagram (RBD) in accordance with an embodiment of the invention.

FIGS. 3 and 4 illustrate examples of user interfaces with risk matrices in accordance with an embodiment of the invention.

FIG. 5 illustrates an example of a part prioritization system that prioritizes system parts in accordance with an embodiment of the invention.

FIG. 6 illustrates an example of a part prioritization element that prioritizes system parts in accordance with an embodiment of the invention.

FIG. 7 illustrates an example of a part prioritization application that prioritizes system parts in accordance with an embodiment of the invention.

### DETAILED DESCRIPTION

Turning now to the drawings, systems and methods in accordance with various embodiments of the invention can use predicted failures and/or the potential impact of such failures to prioritize the sparing of parts in a system to increase and/or optimize system availability. Processes in accordance with a variety of embodiments of the invention can integrate multiple data sets to provide input variables to calculate an expected number of occurrences of a given scenario. For example, processes in accordance with a variety of embodiments of the invention can be used for the prediction of part failures within a system.

In a number of embodiments, outputs from predictive calculations can be coupled with reliability models to present the results in a matrix representation of the highest number of part failure occurrences and their relative impact to the system scenario of interest. Previous methods would often present historical data sets and high level metrics, which are not predictive. Such methods were often unable to provide predictive results based on data distribution models united with system impact.

In constrained environments, access to replacement parts can be difficult, expensive, and/or delayed due to logistic difficulties, such as (but not limited to) part availability, procurement, delivery, etc. In many cases, such systems are designed to be highly reliable, but all systems are subject to failures. Once systems are fielded, system reliability improvements tend not to be as cost effective as logistics investments.

The Navy's primary measure of material readiness is operational availability or Ao, which measures the probability that the system will be ready to perform its specified function, in its specified and intended operational environment, when called upon at a random point in time. At a high level,

$$A o = \frac{M e a n T i m e B e t w e e n F a ilure ( M T B F )}{M T B F + M e a n D o w n t i m e ( M D T )} \qquad ( 1 )$$

Such measurements can provide insight to the expected availability of a part based on historical data, but may not provide insight into part criticality and/or expected failure timelines to meaningfully support sparing decisions.

In a number of embodiments, part prioritization can be used to support complex systems at various levels (e.g., individual systems, interconnected systems, vehicles, fleets, etc.) and provide insight into when part failures are likely to occur, as well as the criticality of such failures. Part prioritization in accordance with numerous embodiments of the invention can have applications in various industries, such as (but not limited to) the auto or oil and gas industry, where systems are constructed of parts that fail and are repaired. Systems and methods in accordance with several embodiments of the invention can be applied to any of a variety of different applications that follow a coupled failure and repair process in order to determine what, when, and where a part is likely to fail and to take steps to limit the impact of the failure on operational availability.

Processes in accordance with a variety of embodiments of the invention can predict a future timeline of part failure occurrences. In various embodiments, predicting the future timeline can be done by incorporating historical part failure data (e.g., from the Material Readiness Database (MRDB) or a similar database of part failure information). The MRDB catalogues failure events that occur on Navy systems. Historical part failure data in accordance with a variety of embodiments of the invention can include (but is not limited to) the failure rate and restore rates of various parts of a system. In a number of embodiments, failures can be assigned to blocks within a reliability block diagram (RBD). RBDs can use blocks to model single points of failure and redundancy within the system that impact system readiness. Parts of a system can be assigned to blocks of an RBD to create or identify connections between the impact of the part to the block and the block to the system, identifying the system impact of a part failure.

Systems and methods in accordance with a number of embodiments of the invention can provide technical solutions to problems arising in the field of logistics. In several embodiments, systems can provide systematic approaches for the prediction of part failures in conjunction with part criticality data to prioritize parts for sparing. While many examples of part prioritization have been described above with respect to part sparing, one skilled in the art will appreciate that part prioritization can be used in a variety of applications, including (but not limited to) order placements, manufacturing planning, budget development, etc., without departing from this invention.

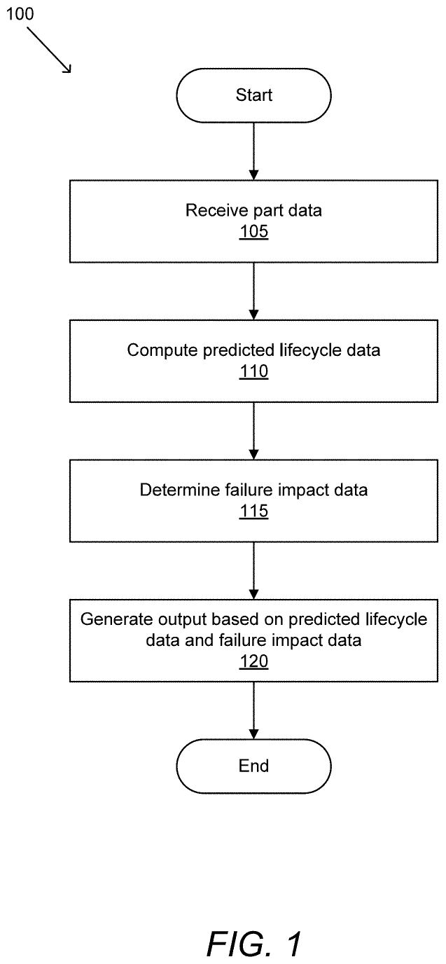

An example of a process for determining part priorities in accordance with an embodiment of the invention is illustrated in FIG. 1. Part prioritization can be performed to determine replacement parts to be maintained in stock for potential failures. In numerous embodiments, part prioritization processes can be updated and monitored, tracking whether predicted parts are actually failing and updating models and inputs with new information.

Process 100 receives (105) part data. Part data in accordance with various embodiments of the invention can provide various information about a part including, but not limited to, part failure data and/or part repair data. Part failure data in accordance with a number of embodiments of the invention can include information related to the failures of parts throughout a system (or across multiple systems), such as (but not limited to) the time since the last failure, failure rates, mean time to failure, how much time it has been used over its lifetime, etc. Part repair data in accordance with a variety of embodiments of the invention can include information related to the repair and/or maintenance of parts in a system, such as (but not limited to) date of last repair, repair rates, a level of effort to repair, availability, estimated time to repair, shipped for repair, estimated requisition time, etc. Part data in accordance with numerous embodiments of the invention can include other information such as, but not limited to, cost, size, and/or weight.

In a variety of embodiments, part data can include impact data that describes an impact to a system for each part. Impact data in accordance with many embodiments of the invention can be calculated based on the last observed failure and/or repair rates. In many embodiments, impact data can be calculated based on failure rates, maintenance levels, and/or employment information reported by a system (or systems).

In numerous embodiments, part data can be received as a constant incoming feed of information that is updated as part data is reported in systems across an organization. In certain embodiments, part data can be retrieved from Material Readiness Database data, where part data can be retrieved by system(s), hull(s), and the expected number of failures will be calculated for a future time, such as a future deployment. Processes in accordance with some embodiments of the invention can retrieve part data for systems along various dimensions, such as (but not limited to), requirements for a particular mission, predicted failures within a given time frame, impact, etc.

Process 100 computes (110) predicted lifecycle data. Predicted lifecycle data in accordance with a variety of embodiments of the invention can include information related to the predicted failures of parts in a system. In certain embodiments, with a part's last fail date, restore rate, and failure rate the expected number of failures can be calculated for each part on every ship where the part has previously failed. Processes in accordance with a number of embodiments of the invention can use historical data to predict when a failure is going to occur using various prediction methods, such as (but not limited to) machine learning and/or linear regression.

An example of a calculation for an expected number of failures is represented by equation (1). In a variety of embodiments, this equation can be modeled after an ordinary renewal process that makes two assumptions: the data is exponentially distributed and a part follows a coupled process of failure and then repair.

$$E ( N ( T + τ ) ) - E ( N ( T ) ) = \frac{λ μ}{λ + μ} τ - \frac{λ μ}{{( λ + μ )}^{2}} ( {e}^{- τ ( λ + μ )} - {e}^{- ( T + τ ) ( λ + μ )} ) \qquad ( 1 )$$

where:

T=Time Since Last Failure Date (Hours)

τ=Deployment Timetable (Hours)

λ=Part Failure Rate

μ=Part Restore Rate

Processes in accordance with a number of embodiments of the invention can use a stochastic process with distributions of what times the part fail and what time they were repaired. These can generate a stochastic process for time to failure.

In a variety of embodiments, a component's time spent in operational and failed states can be modeled as a continuous Markov process. This probabilistic paradigm can describe systems that exist continuously in one of these finite states, changes between the states, and whose current state depends only on the most recent state. For a single part, transitioning from an operational to a failed state occurs at rate λ, the failure rate, and transitioning from a failed to an operational state occurs at rate μ, the restore rate. The component's λ and μ are independent of one another and assumed constant. As a result, the time between failures and the time between repairs can fit an exponential distribution. The failure or repair continuous time stochastic mechanisms can also be characterized as ordinary renewal processes in accordance with numerous embodiments of the invention. Common examples of renewal or arrival processes include radioactive decay and lightning strikes, which “arrive” randomly over time.

Let N, be the number of arrivals. If (t)=0 at t=0, the time between any two arrivals is independently and identically distributed, and for 0≤d<, N(t)−N(d)=the number of events in the interval (d, t], then this ordinary renewal process is also a counting process. In a counting process from (0, t], the expected number of renewals can be calculated as

M(t)=E[N(t)]=Σₖ₌₁^{∞}F^{(k)}(t) (2)

where F^{(k)}(t) is its probability distribution function (PDF) or cumulative distribution function (CDF). In a variety of embodiments, this distribution can be computed from the convolution of the PDF (t) k times, assuming a finite process. The convolved PDF can be integrated from an interval (0, t] to evaluate (t). Mathematical operations with convolution can be more readily manipulated in the frequency domain where convolution is a product. The Laplace transform of (t) is

$$\hat{M} ( s ) = \frac{1}{s} {\sum }_{k = 1}^{∞} {\hat{f} ( s )}^{k} = \frac{\hat{f} ( s )}{s [ 1 - \hat{f} ( s ) ]} \qquad ( 3 )$$

Alternating between two states, in this case an operational state and a failed state, is a special class of an ordinary renewal process called an alternating renewal process. The transitions to the failed and repaired states are coupled (one failure, one repair). Its probability density function, a convolution of two exponential PDFs, is given by the following hypoexponential PDF:

$$f ( t ) = \frac{λ μ}{λ - μ} [ {e}^{- μ t} - {e}^{- λ t} ] \qquad ( 4 )$$

After substituting the Laplace transform of (4) into \hat{M}(s) and then taking the Inverse Laplace transform, the expected or mean number of failures for a part over time t can be defined as

$$E [ N ( t ) ] = \frac{λ μ}{λ + μ} t - \frac{λ μ}{{( λ + μ )}^{2}} ( 1 - {e}^{- t ( λ + μ )} ) \qquad ( 5 )$$

If this part is an element of a larger assembly (e.g., a Navy vessel) to be deployed at time T for a period of T, then the expected number of failures during a deployment can be calculated as

$$E [ N ( T + τ ) ] - E [ N ( T ) ] = E [ N ( Deployment ) ] = \frac{λ μ}{λ + μ} τ - \frac{λ μ}{{( λ + μ )}^{2}} ( {e}^{- τ ( λ + μ )} - {e}^{- ( T + τ ) ( λ + μ )} ) \qquad ( 6 )$$

In many embodiments, a part's failure rate, restore rate, and T (when the alternating renewal started) can be used to evaluate the above equation, where T is the time between when the part was last renewed (put into service) and the deployment start date. In some embodiments, the expected number of failures can be normalized against the maximum. For example, processes in accordance with some embodiments of the invention can group parts based on their expected number of failures into four quarters with the interval between quarters as follows:

Interval==1/4 Max(E[Deployment]) (7)

Parts in the 4th quarter have the highest expected number of failures relative to the maximum expected number of failures. Conversely, parts in the 1st quarter have the lowest expected number of failures compared to the maximum. Relatively, parts in the 4th quarter are more likely to fail and parts in the 1st quarter are less likely to fail because they have less expected number of failures. Processes in accordance with many embodiments of the invention can prioritize or rank parts by their likelihood of failure.

Process 100 determines (115) failure impact data. Failure impact data in accordance with a variety of embodiments of the invention can describe or quantify the impact of a failure of a part at various levels, such as (but not limited to) on a system, a vessel, carrier group, and/or a mission. Failure impact in accordance with certain embodiments of the invention can be determined or represented by system reliability models, such as (but not limited to) reliability block diagrams. In numerous embodiments, reliability block diagrams can be built a hierarchical structure so that failure impact data can be determined by analyzing relationships between parents and children along the hierarchical structure. In various embodiments, system reliability models can be utilized to determine the effect to system operational availability resulting from failure of each part. Processes in accordance with a variety of embodiments of the invention can implement machine learning models trained to predict the impact of part failures on a system based on historic part data.

RBDs in accordance with numerous embodiments of the invention can depict the relationship of system components with respect to reliability and/or mission requirements, and show single points of failure and redundancy. Processes in accordance with certain embodiments of the invention can assign parts to these reliability blocks, which can impact the blocks depending on their criticality. Critical part failures cause failure of the block which may, or may not, cascade up to the system. The impact of a block failure to the system can be categorized as follows:

1) Single Point of Failure blocks that fail will cause the system to enter a failed state. Parts in Single Point of Failure blocks have the highest impact.

2) Reduced Redundancy blocks that fail will not cause the system to enter a failed state but cause a loss of redundancy in the system such that the next block failure within the hierarchy will cause system failure. Parts in Reduced Redundancy blocks have high impact.

3) Redundant blocks that fail will not cause the system to enter a failed state but there is diminished (but not loss of) redundancy within the hierarchy. Parts in Redundant blocks have medium impact.

4) Non-mission Essential (NME) blocks that fail will not cause the system to enter a failed state nor affect redundancy. Parts in NME blocks have low impact.

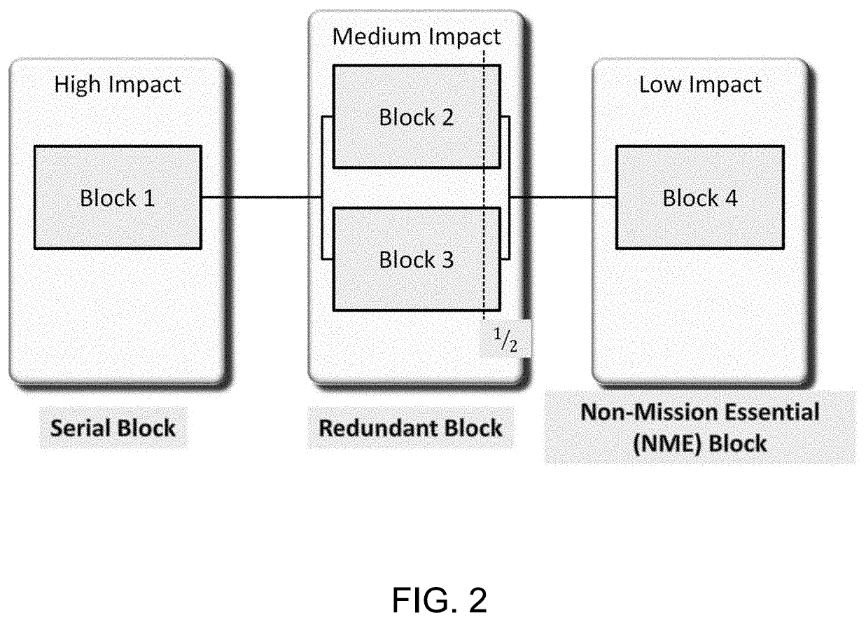

An example of a reliability block diagram (RBD) in accordance with an embodiment of the invention is illustrated in FIG. 2. The diagram of this example shows a serial (or single point of failure) block, a redundant block, and a non-mission essential (NME) block. The serial block contains a single block (Block 1), where failure of Block 1, causes the serial block to fail with high impact. The redundant block contains two alternative blocks (Block 2 and Block 3), where failure of either of the parts does not necessarily lead to failure of the redundant block. These parts may have medium impact. The NME block of this example contains a single block (Block 4). Although failure of Block 4 would lead to failure of the NME block, failure of an NME block can have low impact.

Process 100 generates (120) output based on part data, predicted lifecycle data, and/or failure impact data. Processes in accordance with various embodiments of the invention can compute the expected number of failures and combine this with the impact that the occurrence (or failure) would have on the system from the RBD models in order to generate outputs. In various embodiments, generating outputs can include optimizing for one or more objectives, such as (but not limited to) operational availability, cost minimization, space maximization, etc.

Outputs in accordance with several embodiments of the invention can include various different elements, such as (but not limited to) graphical user interfaces, notifications, alerts, instructions, budgets, reports, part orders, charts, etc. In certain embodiments, generating outputs can include generating sparing budgets that can allocate available parts (e.g., on ship, base pre-deploy for operational deployments, etc.) and/or provide expected expenses for sparing parts according to part prioritizations. By doing so, resources can be allocated aboard and at shore facilities to minimize the effects of potential casualties and maintain effective material readiness. In this way, when parts fail in a manner that could compromise operational availability the part is more likely to be available either onboard or at a nearby facility reducing loss of operational availability to the minimum possible repair time.

In various embodiments, outputs can include a risk matrix. Risk matrices in accordance with certain embodiments of the invention can display prioritized parts, where each number in a cell identifies the number of part installations that have the corresponding block impact and failure likelihood. For example, a risk matrix in accordance with a number of embodiments of the invention may include axes for impact and likelihood, divided into “Highest,” “High,” “Medium,” and “Low” quartiles.

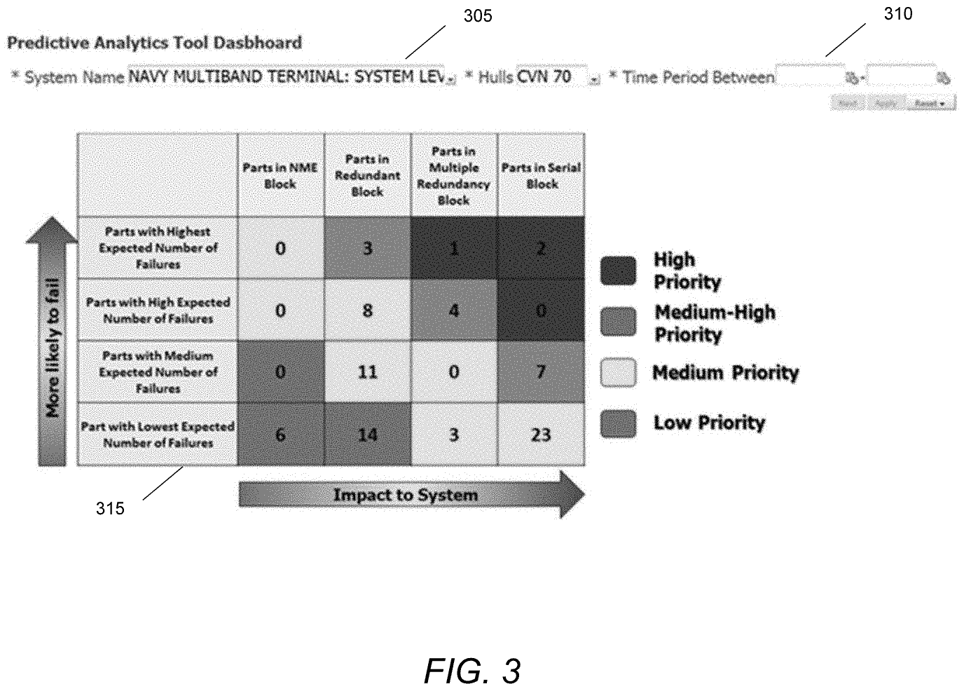

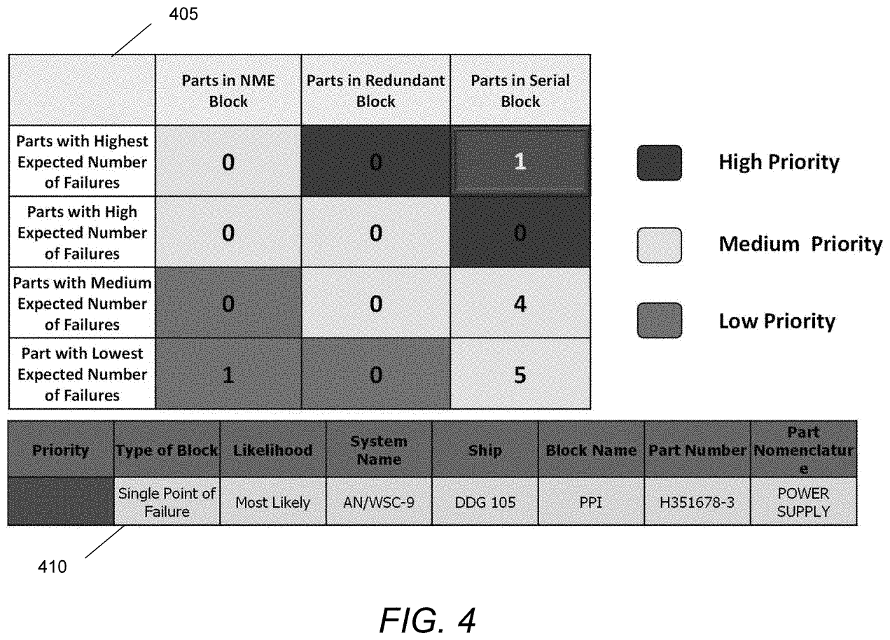

Examples of user interfaces with risk matrices in accordance with a variety of embodiments of the invention are illustrated in FIGS. 3 and 4. In the example of FIG. 3, graphical user interface (GUI) 300 includes system selector 305, date selector 310, and risk matrix 315. System selectors and date selectors can be used to determine parameters for a part prediction, identifying the systems (and associated parts) and time range to be analyzed. Risk matrix 315 shows a 4×4 matrix where parts of the identified system are separated along two axes, the likelihood of failure and impact to the system. Risk matrices in accordance with various embodiments of the invention can provide visual indications of part prioritizations based on their location in the matrix and/or color codes. The example of FIG. 4 includes a similar risk matrix, where the impact to the system is divided into 3 buckets, rather than 4. In addition, the interface of this example includes a table of parts, where the row indicates the priority of the part (e.g., by color) along with other information about each individual part.

Processes in accordance with numerous embodiments of the invention can provide tools to provide personnel with actionable information to effectively reduce the logistics downtime and effects of probable failure events early on. In numerous embodiments, processes can suggest and/or implement supportability enhancements, be it simpler supply chains or more readily available sparing, to improve operational availability. Processes in accordance with a number of embodiments of the invention can place orders and/or initiate transfers based on part prioritization analyses.

While specific processes for determining part priorities are described above, any of a variety of processes can be utilized to prioritize parts as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted. Although the above embodiments of the invention are described in reference to vessels, the techniques disclosed herein may be used in any type of system or system of systems, including vehicle fleets, machinery, etc.

### Systems for Determining Part Priorities

### Part Prioritization System

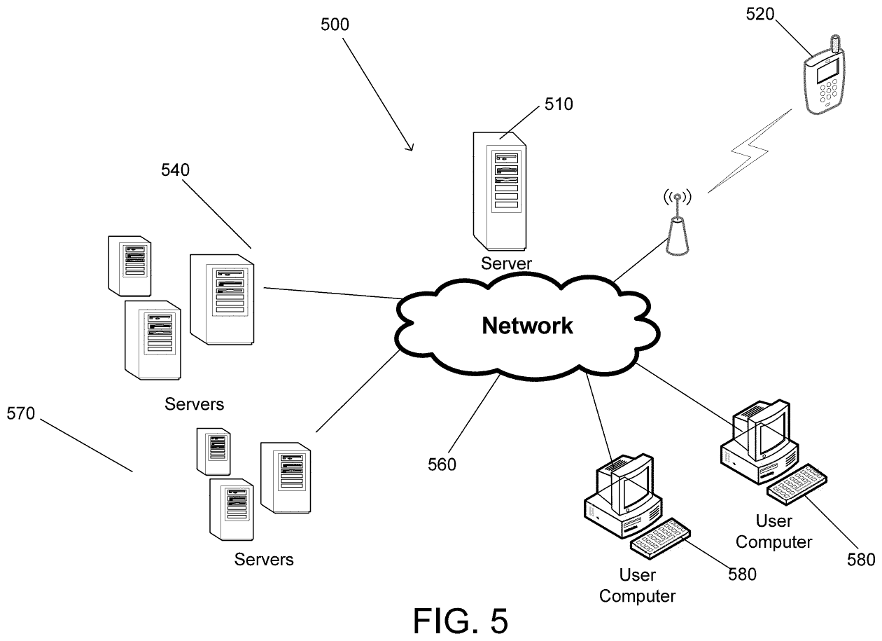

An example of a part prioritization system that prioritizes system parts in accordance with some embodiments of the invention is illustrated in FIG. 5. Network 500 includes a communications network 560. The communications network 560 is a network such as the Internet that allows devices connected to the network 560 to communicate with other connected devices. Server systems 510, 540, and 570 are connected to the network 560. Each of the server systems 510, 540, and 570 is a group of one or more servers communicatively connected to one another via internal networks that execute processes that provide cloud services to users over the network 560. One skilled in the art will recognize that a part prioritization system may exclude certain components and/or include other components that are omitted for brevity without departing from this invention.

For purposes of this discussion, cloud services are one or more applications that are executed by one or more server systems to provide data and/or executable applications to devices over a network. The server systems 510, 540, and 570 are shown each having three servers in the internal network. However, the server systems 510, 540 and 570 may include any number of servers and any additional number of server systems may be connected to the network 560 to provide cloud services. In accordance with various embodiments of this invention, a part prioritization system that uses systems and methods that prioritize parts in accordance with an embodiment of the invention may be provided by a process being executed on a single server system and/or a group of server systems communicating over network 560.

Users may use personal devices 580 and 520 that connect to the network 560 to perform processes that prioritize parts in accordance with various embodiments of the invention. In the shown embodiment, the personal devices 580 are shown as desktop computers that are connected via a conventional “wired” connection to the network 560. However, the personal device 580 may be a desktop computer, a laptop computer, a smart television, an entertainment gaming console, or any other device that connects to the network 560 via a “wired” connection. The mobile device 520 connects to network 560 using a wireless connection. A wireless connection is a connection that uses Radio Frequency (RF) signals, Infrared signals, or any other form of wireless signaling to connect to the network 560. In FIG. 5, the mobile device 520 is a mobile telephone. However, mobile device 520 may be a mobile phone, Personal Digital Assistant (PDA), a tablet, a smartphone, or any other type of device that connects to network 560 via wireless connection without departing from this invention.

As can readily be appreciated the specific computing system used to prioritize parts is largely dependent upon the requirements of a given application and should not be considered as limited to any specific computing system(s) implementation.

### Part Prioritization Element

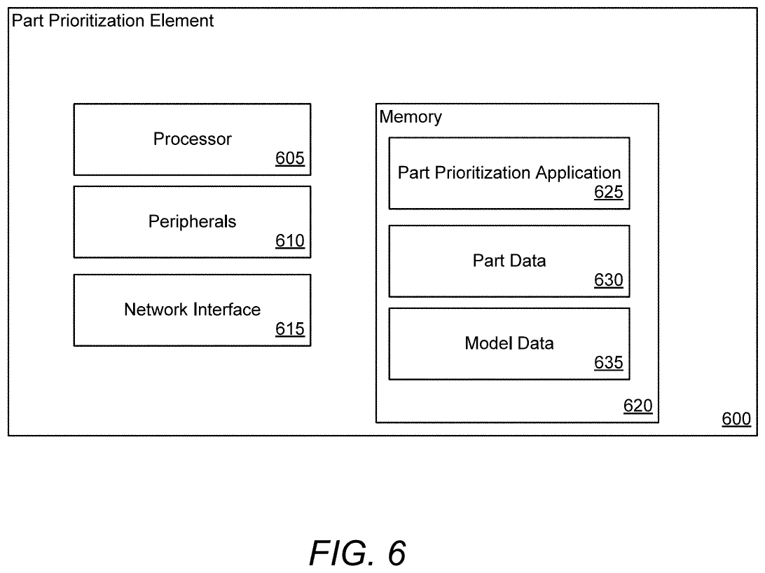

An example of a part prioritization element that executes instructions to perform processes that prioritize parts in accordance with various embodiments of the invention is illustrated in FIG. 6. Part prioritization elements in accordance with many embodiments of the invention can include (but are not limited to) one or more of mobile devices, cameras, and/or computers. Part prioritization element 600 includes processor 605, peripherals 610, network interface 615, and memory 620. One skilled in the art will recognize that a part prioritization element may exclude certain components and/or include other components that are omitted for brevity without departing from this invention.

The processor 605 can include (but is not limited to) a processor, microprocessor, controller, or a combination of processors, microprocessor, and/or controllers that performs instructions stored in the memory 620 to manipulate data stored in the memory. Processor instructions can configure the processor 605 to perform processes in accordance with certain embodiments of the invention.

Peripherals 610 can include any of a variety of components for capturing data, such as (but not limited to) cameras, displays, and/or sensors. In a variety of embodiments, peripherals can be used to gather inputs and/or provide outputs. part prioritization element 600 can utilize network interface 615 to transmit and receive data over a network based upon the instructions performed by processor 605. Peripherals and/or network interfaces in accordance with many embodiments of the invention can be used to gather inputs that can be used to prioritize parts.

Memory 620 includes a part prioritization application 625, part data 630, and model data 635. Part prioritization applications in accordance with several embodiments of the invention can be used to prioritize parts. Part data in accordance with various embodiments of the invention can provide various information about a part including, but not limited to, part failure data and/or part repair data.

Model data in accordance with a number of embodiments of the invention can store various parameters and/or weights for part prioritization models. In a number of embodiments, part prioritization models can be trained for various parts of a part prioritization model, including (but not limited to) predicting expected failure timelines, determining part impacts, and/or determining priorities for different parts based on expected failure timelines and/or part impacts. Model data in accordance with many embodiments of the invention can be updated through training on historic part data captured on a part prioritization element or can be trained remotely and updated at a part prioritization element.

Although a specific example of a part prioritization element 600 is illustrated in FIG. 6, any of a variety of part prioritization elements can be utilized to perform processes for determining part priorities similar to those described herein as appropriate to the requirements of specific applications in accordance with embodiments of the invention.

### Part Prioritization Application

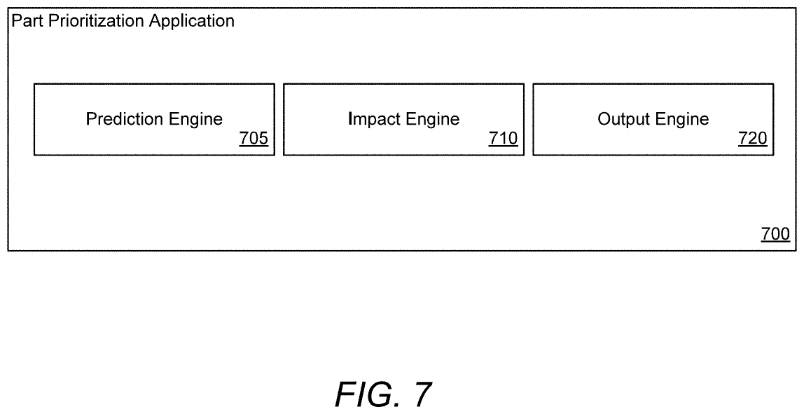

An example of a part prioritization application for determining part priorities in accordance with an embodiment of the invention is illustrated in FIG. 7. Part prioritization application 700 includes impact engine 705, failure prediction engine 710, and output engine 715. One skilled in the art will recognize that part prioritization applications may exclude certain components and/or include other components that are omitted for brevity without departing from this invention.

Prediction engines in accordance with many embodiments of the invention can compute predicted lifecycle data. In a number of embodiments, prediction engines can include one or more machine learning models (such as (but not limited to) artificial neural networks (ANN), linear regressions, binary trees, etc.) to predict lifecycle data. Predicted lifecycle data in accordance with a variety of embodiments of the invention can include information related to the predicted failures of parts in a system, a system as a whole, and/or a group of multiple systems.

Impact engines in accordance with various embodiments of the invention can determine failure impact data. In a variety of embodiments, impact engines can include one or more machine learning models to predict and/or classify part data to determine the failure impact data. Failure impact data in accordance with a variety of embodiments of the invention can describe or quantify the impact of a failure of a part (or system(s)) at various levels, such as (but not limited to) on a system, a vessel, carrier group, and/or a mission. Failure impact in accordance with certain embodiments of the invention can be determined or represented by system reliability models, such as (but not limited to) reliability block diagrams.

Output engines in accordance with several embodiments of the invention can generate outputs based on part data, predicted lifecycle data, and/or failure impact data. In several embodiments, output engines can generate outputs that optimize one or more objectives, such as (but not limited to) operational availability, cost minimization, space maximization, etc. Outputs in accordance with several embodiments of the invention can include various different elements, such as (but not limited to) graphical user interfaces, risk matrices, notifications, alerts, instructions, budgets, reports, part orders, charts, etc.

Although a specific example of a part prioritization application 700 is illustrated in FIG. 7, any of a variety of part prioritization applications can be utilized to perform processes for determining part priorities similar to those described herein as appropriate to the requirements of specific applications in accordance with embodiments of the invention.

Although specific methods of part prioritization are discussed above, many different methods of part prioritization can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for determining part priorities, the method comprising:
receiving part data for a set of one or more parts, the part data comprising part failure data and part repair data;
computing predicted lifecycle data based on the received part data;
determining failure impact data based on the received part data; and
generating an output based on the predicted lifecycle data and the failure impact data.

2. The method of claim 1, wherein the part failure data comprises at least one of the time since the last failure, a failure rate, a mean time to failure, and how much time it has been used over its lifetime.

3. The method of claim 1, wherein the part repair data comprises at least one of a date of last repair, a repair rate, a level of effort to repair, a part availability, an estimated time to repair, and an estimated requisition time.

4. The method of claim 1, wherein the predicted lifecycle data comprises a predicted number of failures for the set of parts over a period of time.

5. The method of claim 1, wherein computing the predicted lifecycle data is performed using a machine learning model.

6. The method of claim 1, wherein computing the predicted lifecycle data comprises modeling a timeline of the part as a continuous Markov process.

7. The method of claim 1, wherein:
determining the failure impact data comprises building a set of reliability block diagrams using a hierarchical structure; and
determining failure impact data comprises analyzing relationships between parents and children along the hierarchical structure.

8. The method of claim 1, wherein determining the failure impact data is performed using a machine learning model.

9. The method of claim 1, wherein generating an output comprises generating a risk matrix, wherein the risk matrix has a first axis indicating a likelihood of failure based on the predicted lifecycle data and a second axis indicating impact of a failure based on the determined failure impact data.

10. The method of claim 1, wherein generating an output comprises generating a sparing budget to allocate available parts for storage on a vessel.

11. A non-transitory machine readable medium containing processor instructions for determining part priorities, where execution of the instructions by a processor causes the processor to perform a process that comprises:
receiving part data for a set of one or more parts, the part data comprising part failure data and part repair data;
computing predicted lifecycle data based on the received part data;
determining failure impact data based on the received part data; and
generating an output based on the predicted lifecycle data and the failure impact data.

12. The non-transitory machine readable medium of claim 12, wherein the part failure data comprises at least one of the time since the last failure, a failure rate, a mean time to failure, and how much time it has been used over its lifetime.

13. The non-transitory machine readable medium of claim 12, wherein the part repair data comprises at least one of a date of last repair, a repair rate, a level of effort to repair, a part availability, an estimated time to repair, and an estimated requisition time.

14. The non-transitory machine readable medium of claim 12, wherein the predicted lifecycle data comprises a predicted number of failures for the set of parts over a period of time.

15. The non-transitory machine readable medium of claim 12, wherein computing the predicted lifecycle data is performed using a machine learning model.

16. The non-transitory machine readable medium of claim 12, wherein computing the predicted lifecycle data comprises modeling a timeline of the part as a continuous Markov process.

17. The non-transitory machine readable medium of claim 12, wherein:
determining the failure impact data comprises building a set of reliability block diagrams using a hierarchical structure; and
determining failure impact data comprises analyzing relationships between parents and children along the hierarchical structure.

18. The non-transitory machine readable medium of claim 12, wherein determining the failure impact data is performed using a machine learning model.

19. The non-transitory machine readable medium of claim 12, wherein generating an output comprises generating a risk matrix, wherein the risk matrix has a first axis indicating a likelihood of failure based on the predicted lifecycle data and a second axis indicating impact of a failure based on the determined failure impact data.

20. A system for determining part priorities, comprising:
a non-transitory machine readable medium containing processor instructions for determining part priorities, where execution of the instructions by a processor causes the processor to perform a process that comprises:
receiving part data for a set of one or more parts, the part data comprising part failure data and part repair data;
computing predicted lifecycle data based on the received part data;
determining failure impact data based on the received part data; and
generating an output based on the predicted lifecycle data and the failure impact data.
